(19) United States
(12) Patent Application Publication
(10) Pub. No.: US 2026/0019288 A1
(43) Pub. Date: Jan. 15, 2026

(54) BLOCKCHAIN AND ARTIFICIAL INTELLIGENCE FOR SECURE DATA MANAGEMENT

(71) Applicant: ProveAl, LLC, San Diego, CA (US)

(72) Inventors: Mrinal MANOHAR, San Diego, CA (US); Henry GUO, San Diego, CA (US); Justin KENNEDY, San Diego, CA (US)

(21) Appl. No.: 19/268,913

(22) Filed: Jul. 14, 2025

Related U.S. Application Data
(60) Provisional application No. 63/671,580, filed on Jul. 15, 2024.

(51) Int. Cl. H04L 9/00

(52) U.S. Cl. CPC H04L 9/50

(57) ABSTRACT

Systems and methods here may be used to secure data for use in AI systems training datasets, machine learning model metadata, and contextual metadata for advanced AI models via a hybrid blockchain backend. The AI systems data is stored via a private blockchain and then utilizes an orchestration event management system to filter and store specific information on a public blockchain. The important AI systems data will then be stored via a smart contract mechanism that is version controlled and immutable. This way AI systems data can be properly traced, securely stored, and properly managed by incorporating blockchain technology.

### CROSS-REFERENCE TO RELATED APPLICATIONS

This application claims the priority benefit of U.S. Provisional Patent Application No. 63/671,580, filed on July 15, 2024 and entitled "BLOCKCHAIN AND ARTIFICIAL INTELLIGENCE FOR SECURE DATA MANAGEMENT," the contents of which are incorporated herein by reference in their entirety.

### TECHNICAL FIELD

This application relates to the field of providing a tamper-proof and auditable artificial intelligence and machine learning data management and governance system by incorporating a hybrid blockchain solution.

### BACKGROUND

Data is growing at an unprecedented rate. By 2025, its global volume is projected to reach 175 zettabytes. A lot of this data is being fed into artificial intelligence (AI) and especially generative Al models. These Al have to deal with massive volumes of structured and unstructured data in various formats (text, image, video, and audio, among others) from multiple different sources. The challenge of securing this data for Al model training and knowing how reliable this data is a tall order. Even after an Al model is securely and professionally trained and goes into production, there's the added challenge of ensuring the models and the data streams haven't been tampered with, corrupted, or just performing to a societal or ethical standard that is compliance with laws and regulations is one of the most important issues relating to adopting and usage of Al.

Systems and methods here help solve these technical problems by providing an end-to- end secure, tamper-proof, serialized, and automated system to manage, govern, and monitor the usage of machine learning training data for both traditional Al and generative Al by securing this system workflow via blockchain technology as described herein.

### SUMMARY

Systems and methods here include ways to secure data for use in AI systems training datasets, including receiving new data from a data source, filtering, by an orchestration event manager, the received new data to determine whether the new data is descriptive or mission specific, causing storage, by the orchestration event manager, of a first subset of the new data, determined to be descriptive, on a non-blockchain database, causing storage, by the orchestration event manager, of a second subset of the new data, determined to be mission specific, on a private blockchain, causing storage, by the orchestration event manager, of secure computer security hash information from the private blockchain storage, to a public blockchain. Some examples include, alone or in combination, where the second subset of the new data is stored on the private blockchain by smart contract. And in some examples, alone or in combination, the smart contract includes AI metadata information including dataset, AI model, model context, model versioning, model identifier, model provider, and generative AI prompt-based information. Some examples include, alone or in combination, calling a specific contract version and an associated AI model, each stored on the private blockchain in a collection of all possible versioning for AI system metadata information. Some examples include, alone or in combination, linking the descriptive information stored on the non-blockchain databases with mission specific data stored on the private blockchain. Some examples include, alone or in combination, the second subset of data includes at least one of, AI training dataset information like dataset type, short description, associated tags, personally identifiable information (PII), known copyright information. Some examples include, alone or in combination, the orchestration event manager receives, stores and filters events from a public blockchain node regarding state changes. Some examples include, alone or in combination, the events from the public blockchain node are parsed by a blockchain event handler before being passed on to the orchestration event manager. Some examples include, alone or in combination, the events from the public blockchain node are cached in an external database to maintain a historical chronology of events in the event that a monitoring client disconnects. Some examples include, alone or in combination, the blockchain event handler periodically checkpoints a capability to post a state root hash of the private blockchain to the public blockchain. Some examples include, alone or in combination, the private blockchain includes blocks with version histories and smart contracts and the public blockchain includes blocks with proprietary trust and smart contracts. Some examples include, alone or in combination, the smart contracts are configured to track history of AI dataset parameters, AI model parameters, AI model context parameters, and session information for cryptographic storage of AI data information until a public blockchain that is accessible via a decentralized ledger format is available. Some examples include, alone or in combination, causing storage, by the orchestration event manager, of additional data to the public blockchain, after receiving instruction from a user.

Methods and systems described here may be used for securing data, including, storing and retrieving data, by an event orchestrator push model, from a circular buffer filtering data for storing in a public blockchain via a private blockchain instance. Some examples include, alone or in combination, the circular buffer includes a forced serialization of asynchronous events. Some examples include, alone or in combination, by an AI system, storing descriptive information on non-blockchain databases, linking the descriptive information stored on the non-blockchain databases with mission associated and secured information stored on the private blockchain.

### BRIEF DESCRIPTION OF THE DRAWINGS

For a fuller understanding of the nature and objects of the disclosure, reference should be made to the following detailed description, taken in connection with the accompanying drawings, in which:

FIG. 1 is a diagram showing example system architecture as described in the embodiments disclosed herein.

FIG. 2 is a diagram showing an example data flow chart as described in the embodiments disclosed herein.

FIG. 3 is a diagram showing an example data flow chart as described in the embodiments disclosed herein.

FIG. 4 is a diagram showing an example data flow chart as described in the embodiments disclosed herein.

FIG. 5 is a diagram showing example system architecture as described in the embodiments disclosed herein.

FIG. 6 is a diagram showing example system architecture as described in the embodiments disclosed herein.

FIG. 7 is a diagram showing example system architecture as described in the embodiments disclosed herein.

FIG. 8 is a diagram showing example flow chart as described in the embodiments disclosed herein.

FIG. 9 is a diagram showing example smart contract as described in the embodiments disclosed herein.

FIG. 10 is a diagram showing example system architecture as described in the embodiments disclosed herein.

FIG. 11 is a diagram showing example system architecture as described in the embodiments disclosed herein.

FIG. 12 is a diagram showing example blockchain architecture as described in the embodiments disclosed herein.

FIG. 13 is a diagram showing example computer network system which may be used to practice the embodiments disclosed herein.

FIG. 14 is a diagram showing example computer system which may be used to practice the embodiments disclosed herein.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known data structures, timing protocols, software operations, procedures, and components have not been described in detail so as not to unnecessarily obscure aspects of the embodiments of the invention.

### Overview

Systems and methods here may utilize blockchain implementation to provide a tamper- proof and immutable source of truth for the history of an organization's artificial intelligence and machine learning data management system. These systems and methods may be used to help solve data security problems that currently exist in the data storage used today. Current and previous solutions do not provide a secure tamper-proof mechanism to ensure data in storage, data in transit, and data ingestion have been properly secured in a verifiably trusted format as provided by a hybrid blockchain solution. This is a problem because of the sensitivity of data that is used to train AI and large language models. If improper data is used for such training, the resultant system may produce undesirable query returns. Further, if malicious actors are able to inject malicious data into training sets, the results may be undesirable. Therefore, there is a great need for having a secure method to store data used to train models which is persistent and verifiable.

Systems and methods here include an end-to-end secure, tamper-proof, serialized, and automated system to manage, govern, and monitor the usage of machine learning training data for both traditional AI and generative AI. Such systems and methods include the utilization of AI management systems via hybrid blockchain technology as described herein. A hybrid blockchain, as described herein, ensures the data provenance and access control has been properly secured, and auditable and ensures the data lineage is traceable in an immutable manner. Such system and methods are described herein.

In this description, the term AI can mean any range of machine learning, artificial intelligence, generative artificial intelligence, systems that use large language models, neural networks, or any other kind of trainable systems that use models, the term is not intended to be limiting.

### System Architecture Examples

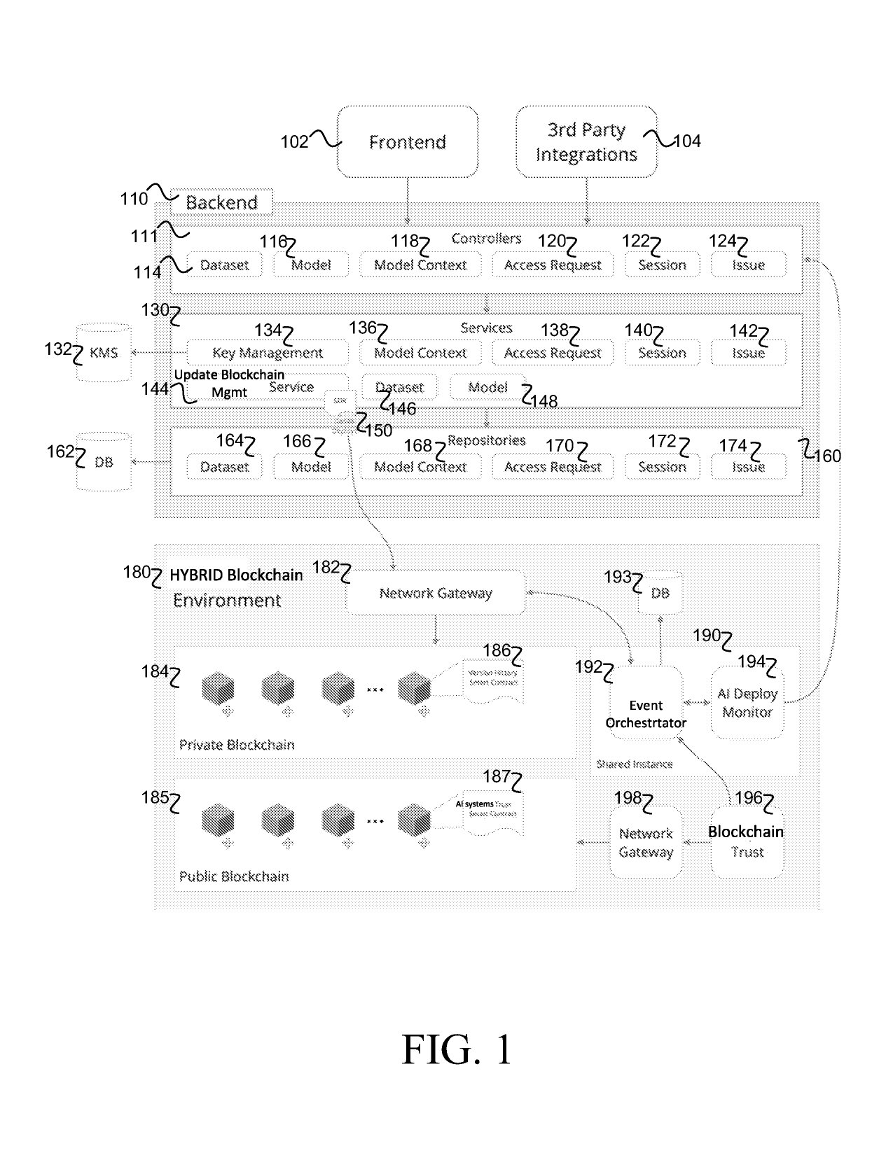

FIG. 1 is a screenshot depicting an example of how AI and machine learning data will be stored via a hybrid blockchain solution. It details the type of data to be captured and how it will be stored securely via a private blockchain instance with built-in logic to transfer secure computer security hash information to a public blockchain.

FIG. 1shows an example architecture which utilizes the described hybrid blockchain arrangement to secure data as described. FIG. 1 shows how a front end 102 and in some examples, any number of third-party integrations from AI and machine learning data sources 104, can interface with a backend middleware system 110. Such interface could be through any number of Application Programming Interface (APIs), etc. The interface with the backend 110 may include through a controller module 111 such as a dataset 114, model 116, model context 118, data access request or model access request 120, session 122, issue 124, etc. The controller module 111 handles Hypertext Transfer Protocol (HTTP) requests, validates incoming data, and delegates business logic to the service module 130 for the purpose of capturing, filtering, and storing metadata associated with AI datasets and models.

The controllers 111 may interface with a services module 130. Such services module 130 may include its own database storage 132 as well as any number of functions, such as, but not limited to, key management for cryptographic key infrastructure used to bind public keys with respective identities of organizations, users, and auditors to ensure tamper-proof accountability and audibility 134, the key management module is the controller and cryptographic key custodian of different public and private keys used to the validity of AI dataset, models, and model context information via tamper-proof accountability 136, AI model context information is processed via microservices 138, AI dataset and model access requests are processed via microservices 140, AI session information is processed via microservices 142, update blockchain management takes incoming secure data requests and manages the service to store specific mission-associated AI data, AI model, and AI model context information onto tamper-proof blockchain 144, AI model dataset information is processed via microservices 146, and AI model information is processed via microservices 148. In some examples, microservices may be or include service modules. In some examples, update blockchain management services 144 function may include a software development kit (SDK) 150 that is configured to send and deploy to a network gateway 182 as shown. Such arrangement may be used for the secure storage of specific mission-associated AI data, AI model, and AI model context information onto a tamper-proof hybrid blockchain, according to the embodiments described herein.

The services module 130 may interface with a repositories module 160. Such a repositories module 160 may have its own database storage 162 as well as any number of functions such as but not limited to AI datasets 164, AI models 166, AI model contexts 168, access requests 170, generative AI session information 172, and issue resolutions 174. This is for the secure capture of the data repository that flows downstream from the Controller modules to the Services modules. The data is then stored within 162 databases and transmitted to a hybrid blockchain via 182 network gateways.

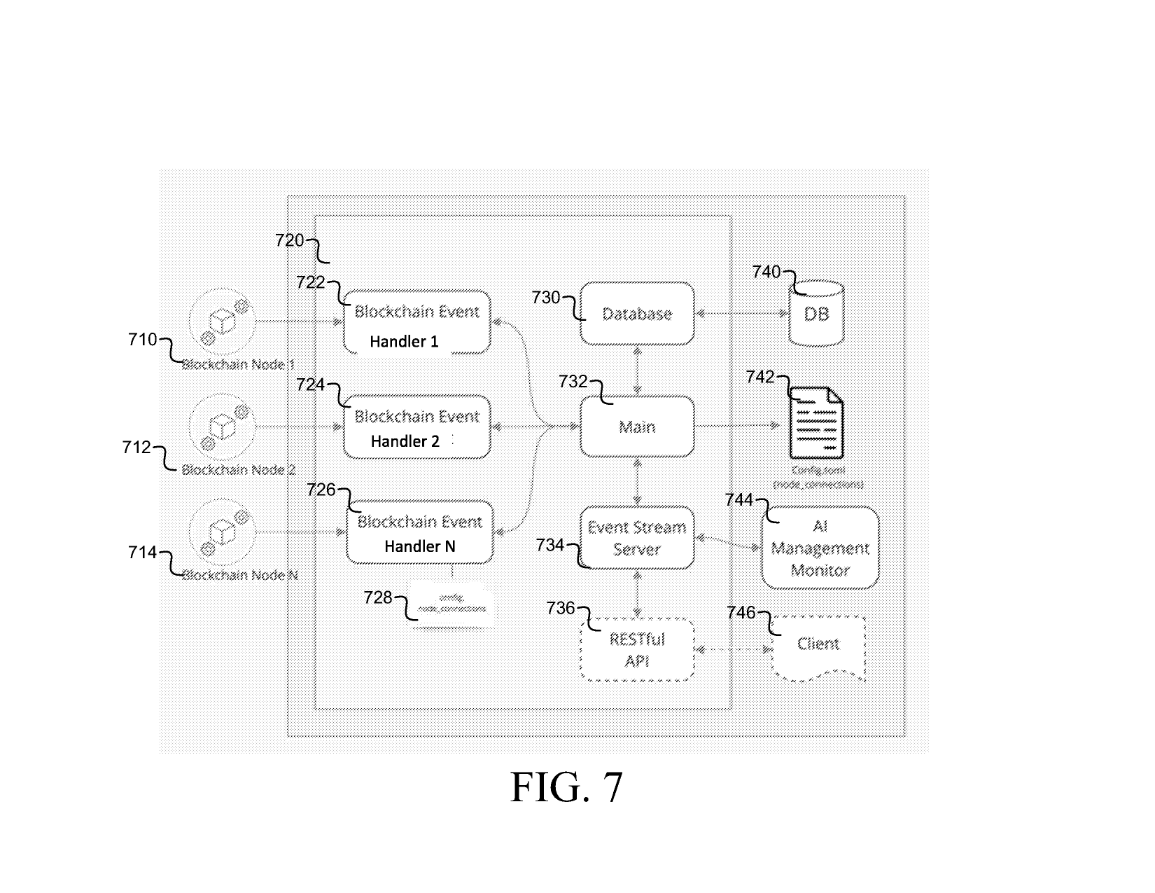

FIG. 1 shows how the network gateway 182 in communication with the SDK 150 in a hybrid blockchain environment 180 that includes both a private blockchain 184 and a public blockchain 185. The hybrid blockchain deployment may include a custom smart contract to support core AI systems data tracking, traceability, and audibility. In some examples, the blocks of the private blockchain may include blocks with version histories and smart contracts 186. In some examples, the public blockchain may include blocks with proprietary trust and smart contracts 187. These AI systems trust smart contracts 187 may be configured to track the history of AI dataset parameters, AI model parameters, and AI model context parameters, and session information. This is for the cryptographic storage of AI data information until a public blockchain that is accessible via a decentralized ledger format 185 is available. The public blockchain implementation 185 provides a tamper proof and immutable source of truth for the history of an organization's AI system, and for tracking operational processes. The network gateway 182 may also be in communication with a shared instance 190 which may include an event orchestrator 192 and an AI deploy monitor 194. In some examples, the event orchestrator 192 includes its own database storage 193. In some examples, the AI deploy monitor 194 may be in communication with the controllers 111 as shown. This is for monitoring of AI systems transaction results by querying the event orchestrator 192. The blockchain trust 196 will periodically checkpoint the capability to post the state root hash of the private chain 184 to the public chain 185. In some examples, the network gateway 198, that is similar to network gateway 182, ensures the system can properly interact between blockchain networks may be arranged to interface with the public blockchain 185 and also receive from the proprietary blockchain trust 196 which interfaces with the event orchestrator 192. The event orchestrator 192 is explained in more detail in FIG. 7. This example may be used for middleware service to reliably consume, store and filter events that a blockchain node emits on state changes to the public blockchain. The event orchestrator 192 uses a push model to store and retrieve data in a circular buffer to protect the integrity of the public blockchain and filter out specific information to be stored in the public blockchain via a private blockchain instance. The circular buffer architecture acts as a forced serialization of asynchronous events to ensure data is properly stored in a tamper-proof and secure manner on the blockchain as shown in FIG. 1 for AI systems data.

### Registration and Consumption of Dataset Examples

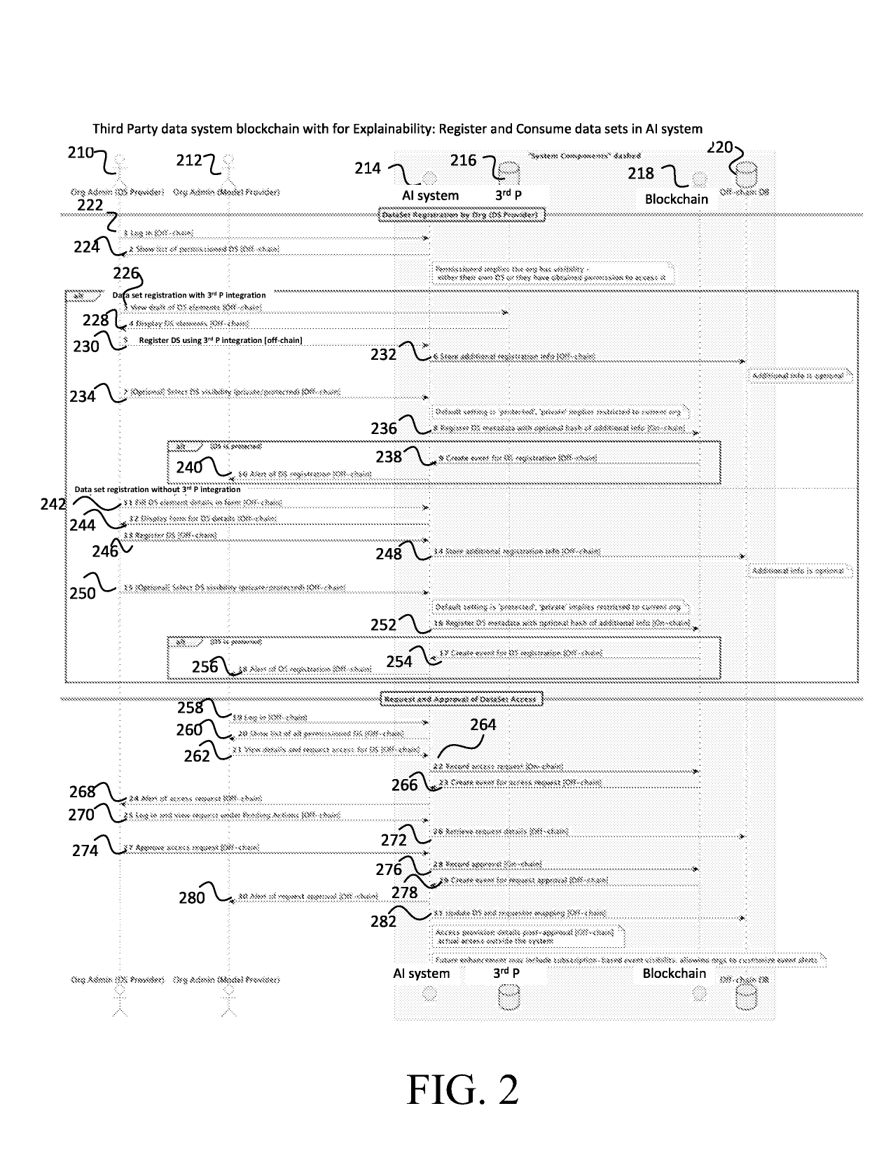

FIG. 2 describes a data flow of how a user may use software to capture AI datasets used to train machine learning models that are verified and then stored on a blockchain. In such examples, machine learning data may be analyzed and assessed by the system to determine if it can be stored on a blockchain for security. In such examples, user groups associated with the workflow of the AI systems may model data set management and capture data set information via blockchain technology. In FIG. 2, the actors include a user group for the dataset provider, an organization user that uses AI systems to capture the data set information needed to build AI models 210. An organization administrator 212 may use AI systems to create, train, track, and manage machine learning models. The organization administrator 212 may be responsible for building, editing, updating, and managing the overall lifecycle of machine learning models. The organization administrator 212 may register and/or manage AI models on the platform. Also shown is the AI system itself, 214, third-party systems, 216, and a secure hybrid blockchain system 218 using both public and private blockchain as well as off-blockchain databases, 220.

As shown in FIG. 2, first, the dataset provider 210 interacts with AI management and governance systems via 222 by logging in. In return, the AI system 214 returns a list of permissioned data sets, off chain 222 to the data set provider 210. The model provider 212 interacts with AI management and governance system 216 via 222 by logging in (not pictured). The dataset provider 210 then checks the status of the AI dataset within the AI systems platform to verify which organizations can have access to the AI dataset to train and fine-tune AI models by querying 214 the AI system which pulls from third party systems in 216. This information is verified via 218 the secure hybrid blockchain which is cross-checked via 220 off-blockchain databases.

The querying between the data set provider 210 and the third party 216 of the information if it is in draft mode 226 will be done via off blockchain as draft mode data is not needed to be securely stored via a tamper-proof blockchain instance. In return, the third party 216 may provide or display back the dataset elements that do not need to be securely stored via a tamper- proof blockchain 228. Next, the data set provider 210 may then register 230 the descriptive dataset, that is, data not needed for substantive training or just descriptive data or information like draft status to the AI system 214. In turn, the AI system may cause storage 232 in the off- chain storage 220, or additional AI systems metadata that is not mission specific to AI systems data and model integrity. Data set provider users 210 may then select 234 off blockchain optional data. Next, the AI systems 214 may cause the official dataset information, determined by the system to be blockchain worthy, to be stored 236 on a blockchain 218 as this information is needed to properly track and trace the origins of the datasets used to train AI models. Non- limiting examples of such data may include but not be limited to, AI training dataset information like dataset type, short description, associated tags, PII, known copyright information, and if a known program has filtered out undesired data such as that containing hate speech, abusive language, profanity, or any other undesired data contained with the datasets. In some examples, the dataset confirmation 238 may be sent back from the blockchain system 218 to the AI system 214 and any undesired data or information will not be stored on a blockchain 218. The AI system 214 may also send along with the confirmation data updates and alerts 240 to the model provider 212 user to let them know that the dataset is available to be used to train AI models.

FIG. 2 data flows 242, 244, and 246 take the same steps to register a dataset for AI model training purposes as the same as automated data pull but each data set element may need to be manually entered instead of pulling directly from a third-party system. In some examples, the AI system 214 may inform the model provider 212 of the logging off information associated with users this information is deemed descriptive and will be stored off the blockchain 256.

Next, the model provider, 212 may log in 258 to the AI system 214. Next, the AI system 214 sends a list 260 of all permissions associated with datasets registered within the AI systems and returns this information to users 212. This data or information may be considered descriptive or deemed not worthy of storage on a blockchain. Next, the user 212 may view 262 details and request access for data sets not stored on the blockchain. The AI system 214 may capture 264 all record access requests and contains AI systems and model integrity information which is stored on a blockchain 218. In such examples, the blockchain 218 may return access request permission data 266 which is descriptive and not deemed worthy of storage on a blockchain. The AI system 214 may sets the alerts 268 to dataset providers 210 and this information is not stored on a blockchain. Dataset providers 210 may view 270 pending requests associated with AI datasets and this information is deemed descriptive and not stored on blockchain. The AI system 214 may then retrieve request details 272 from a non-blockchain database 220. Then the dataset provider user 210 may send an approval request 274 to the AI system 214 to approve access to AI datasets for model training. Then the AI system 214 may capture the mission associated information, deemed worthy of blockchain storage, of which AI datasets are approved, by which organization, and the timestamp and send to the blockchain 220 for storage 276. In return the blockchain 220 creates the request approval 278 and alerts 280 the model provider 212 of the access requests to AI training datasets. The AI system 214 may update 282 all the information regarding the AI dataset access information and causes storage 220 of this descriptive data on the off chain 220.

### Model Registration and Access Workflow Examples

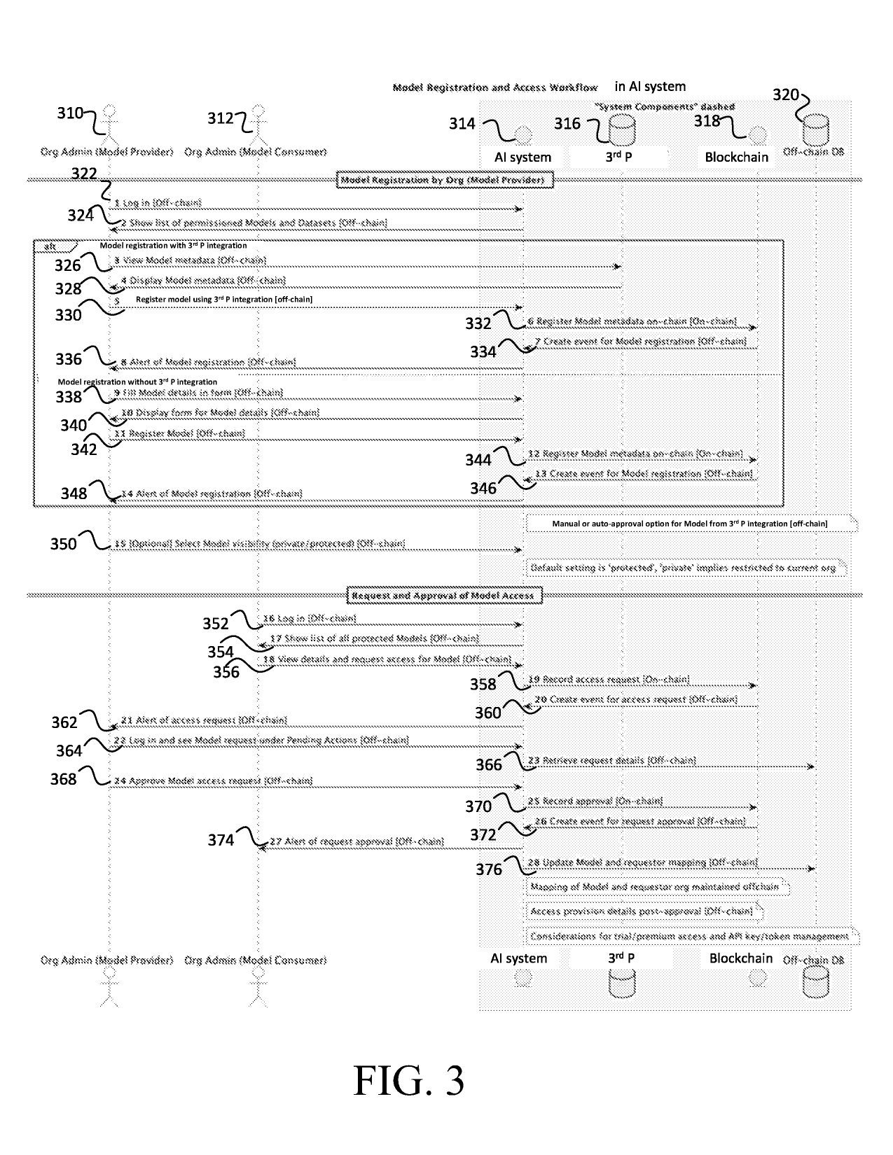

FIG. 3 describes a data flow of how a user may use software to identify, review, and store important machine learning model metadata onto a secure blockchain. The workflow shows the users and steps needed to verify AI model description information and the correct format to store the information onto a blockchain for secure tamper-proof AI systems management. Certain machine learning data pertaining to the user's machine learning model may be analyzed to determine whether it is worthy of storage on a blockchain for security.

FIG. 3 shows actors in the data flow diagram with the user group 310 for the model provider, an organization user that uses AI systems to create, train, track, and manage machine learning models for internal organization and external organization usage. Next the user group model consumer, 312, an organization user that uses AI systems to run the AI model inference. The AI model can be run in its original untuned state, fine-tuned, prompt-tuned, and/or edited state. The AI systems capture each version of the AI model inferences and log important information onto a blockchain. The model consumer can view details related to AI models on the platform and run the inference version of the AI model. Also shown are the AI systems 314 which pull from third party systems, 316. This information is verified via secure hybrid blockchain 318 which may be cross-checked via 320 off-blockchain databases. This information is verified via 318 secure hybrid blockchain which are cross-checked via 320 off-blockchain databases (not pictured).

The data flow of FIG. 3 begins with the model provider 310 sending a log in request 322 to the AI system 314 for AI management and governance. In response, 324, the AI system provides a list of permissioned models and datasets to the model provider 310. That allows the model provider 310 to send a request 326 to the third parties 316 to view model metadata that allows the user to check the status of the AI models within the AI systems platform to verify which organizations can have access to the AI model to view, edit, and/or fine-tune AI models. The querying of the information via 3rd part systems 326 automates the detection and determines what AI model metadata to pull into the AI system from third party system. The third-party providers 316 may send or display back 328 the AI model metadata elements that can be directly pulled from third party systems 316. The model provider 310 may then register 330 the AI model metadata information from third party systems into the AI system 314 for risk and governance management purposes. The AI system 314 may initiate initial contact information 332 to the blockchain 318 and register the third-party AI model metadata information onto the blockchain 318. The blockchain 318 may create and send event and acknowledge data 334 from the blockchain 318 back to the AI system 314. The blockchain 318 may also return the deployment cryptographic hash value for tracking purposes with the AI system. The AI system 314 may return the alert 336 to the model provider 310 that the direct and automated AI model metadata information pulled from third party system 316 was a success and stored onto the blockchain 318.

The model provider 310 may initiate 338 a more manual entry of AI model metadata information at the AI system 314. Details associated with AI model information may be entered within the AI system 314. The AI system 314 may cause display 340 of the detailed AI model registration form along with important input information fields to the model provider 310. The model provider 310 may register 342 the AI model information to the AI system 314 which captures important AI model metadata and causes storage 344 on the secure tamper-proof blockchain 318. This information is needed to properly track and trace the origins of the AI models and model detail information like who is the original model provide 310, the version of the model, which datasets were used to train the model, associated tags, if PII, known copyright information, and if a known program has filtered out hate speech, abusive language, and profanity associated with the AI model associated with training datasets for the AI model. This specific AI model detail information may be stored onto the tamper-proof blockchain 318. The blockchain 318 may return 346 acknowledgment and deployment cryptographic hash value for tracking purposes with the AI system 314. The AI system 314 may return the alert 348 to the model provider 310 that the manual AI model metadata information entered was a success and stored onto the blockchain 318.

In some example embodiments, the model provider 310 may edit the AI model status 350 within the AI system 314 to determine if it is private and can only be viewed by the model provider 310 or protected state where it can be shared with other approved parties.

In some examples, a model consumer 312 may log in 352 to the AI system 314. In return, the AI system 314 may return a list 354 of protected AI models that are viewable by the model consumer 312. The model consumer 312 may then view summarized information 356 on AI models within the AI system 314 that is viewed by model consumers 312 and requests access to the AI model. In such examples, the AI system 314 causes storage 358 of the access rights request associated with the model consumer 312 onto the blockchain 318. In such examples, the blockchain 318 may return acknowledgement 360 to the AI system 314. The AI system 314 may return an alert 362 to the model provider 310 informing them an AI model access right request has been submitted by a model consumer user 312. The model provider 310 may log into 364 the AI system 314 and see a list of AI model access requests. The AI system 314 may retrieve 366 the list of all AI model access requests from the off-blockchain database 316. The model provider 310 may accept and grant 368 AI model access requests within the AI system 314. The AI system 314 may captures this information 370 and cause storage of it onto the blockchain 318 for proper auditability purposes. The blockchain 318 may return the acknowledgement 372 from the blockchain on this AI model access request to the AI system. The AI System 314 may alert 374 the model consumer 312 that they have received access rights to the AI model. Once the model consumer 312 gains the proper access rights can access the AI model details which include the original model provider 310, the version of the model, timestamp, which datasets were used to train the model, associated tags, if PII, known copyright information, and if a known program has filtered out hate speech, abusive language, and profanity associated with the AI model associated with training datasets for the AI model. The AI system 314 may then send an update 376 mapping of user rights associated with AI model registered within the AI system 314 to the data storage 320.

### Model Issue Reporting and Context Registration Examples

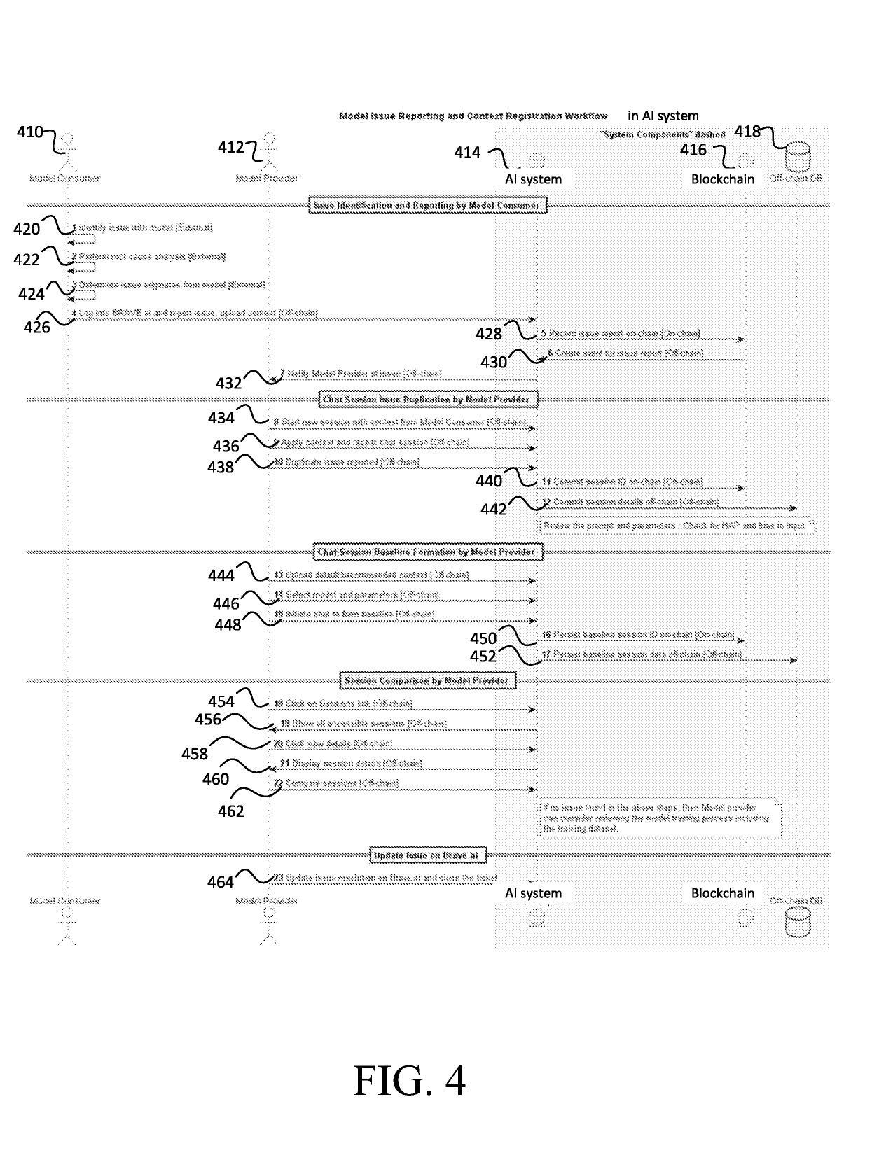

FIG. 4 describes a data flow of how a user may use software to identify, test, and report machine learning models that are securely stored with blockchain storage to AI systems to track, trace, and resolve AI related incidents associated with model context information and generative AI session parameters. The workflow of FIG. 4 shows the users and steps needed to test, store, capture, save, and resolve predictive and generative AI model information that pertains to model context information and session details. This is resolved by saving and loading this information and assigning them to issues for model providers to resolve.

Actors in the data workflow of FIG. 4 include a user group model consumer 410, an organization user that uses AI systems 414 to run the AI model inference. The AI model can be run in its original untuned state, fine-tuned, prompt-tuned, and/or edited state. The AI systems 414 capture each version of the AI model inferences, model context information, and for generative AI purpose session-related information. All this information may be captured and stored on a blockchain 416. The model consumer 410 can view details related to AI models on the platform to run the inference version of the AI model within a generative AI prompt chat sandbox and change different context information to ensure the AI model is behaving as expected. A model provider user group is also depicted 412 as an organization user that uses AI systems to create, train, track, and manage machine learning models for internal organization and external organization usage. AI system 414 is shown that users interact with and it automates the storage of mission associated AI system management information on the secure hybrid blockchain 416 which is cross-checked via off-blockchain databases 418. The model consumer 410 may interact with AI management and governance systems by 420 to identify issues associated with AI models registered on the AI system. The model consumer 410 may perform a root cause analysis 422 outside the AI system bounds by witnessing the AI model performing erroneously or outputting bad results. In such a way, the model consumer 410 may determine the issues 424 associated with the AI model.

The model consumer 410 then logs into 426 the AI system 414 to report the information and provides the model version, model details, and context associated with the AI model. The issue is reported 428 by the AI system 414 and an issue identification number and session information associated with the issue and sent to the blockchain 418. This information includes the model identification number, context name, context short description, and context parameter details which include information pertaining to the AI model decoding method, min/max tokens, AI model temperature settings, top K, top P, and other relevant model parameter details. This information is stored on a secure tamper-proof blockchain 418 that can be accessed and retrieved to showcase the exact model information and output details. The blockchain 416 returns the event issue acknowledgment 430 to the AI system 414. The AI system 414 alerts 431 the original model provider 412 of the issues associated with the AI model they created.

The model provider 412 reviews the model context and session information associated with the issue identification number that was alerted to them 434 to the AI system 414. The model provider 412 applies the same model context and session information 436 within the generative AI sandbox environment which duplicates the issue and repeats the same chat session 438. The AI system 414 stores this context and information 440 onto the blockchain 416. The AI system 414 causes storage 442 of descriptive information on the databases 418 and links it with the mission associated and secured information stored on the blockchain 416.

The model provider 412 uploads the default model context information 444 to the AI system 414 and selects different model context information to test and try to triage the AI model issue by changing the different contexts. The model provider 412 initiates the secure generative AI sandbox session 448 and stores this information 450 onto the blockchain 416. Descriptive information associated with the model context and session is stored 452 within the non- blockchain database 418.

The model provider 412 clicks on the session link 454 at the AI system 414 which causes display 456 of all the accessible sessions that were reported to the model provider 412. The model provider 412 clicks on a button 458 to expand details associated with the session and the expanded details are shown in 460 by the AI system 414. The model provider 412 is able to compare and contrast the results 462 from the reported issue from the model consumer 410 and duplicate and edit model context output via the secure generative AI sandbox environment. This comparison gives the model provider the ability to triage and resolve the issue. The model 412 provider updates the resolution of the issue 464 within the AI system 414.

### Additional Architecture Examples

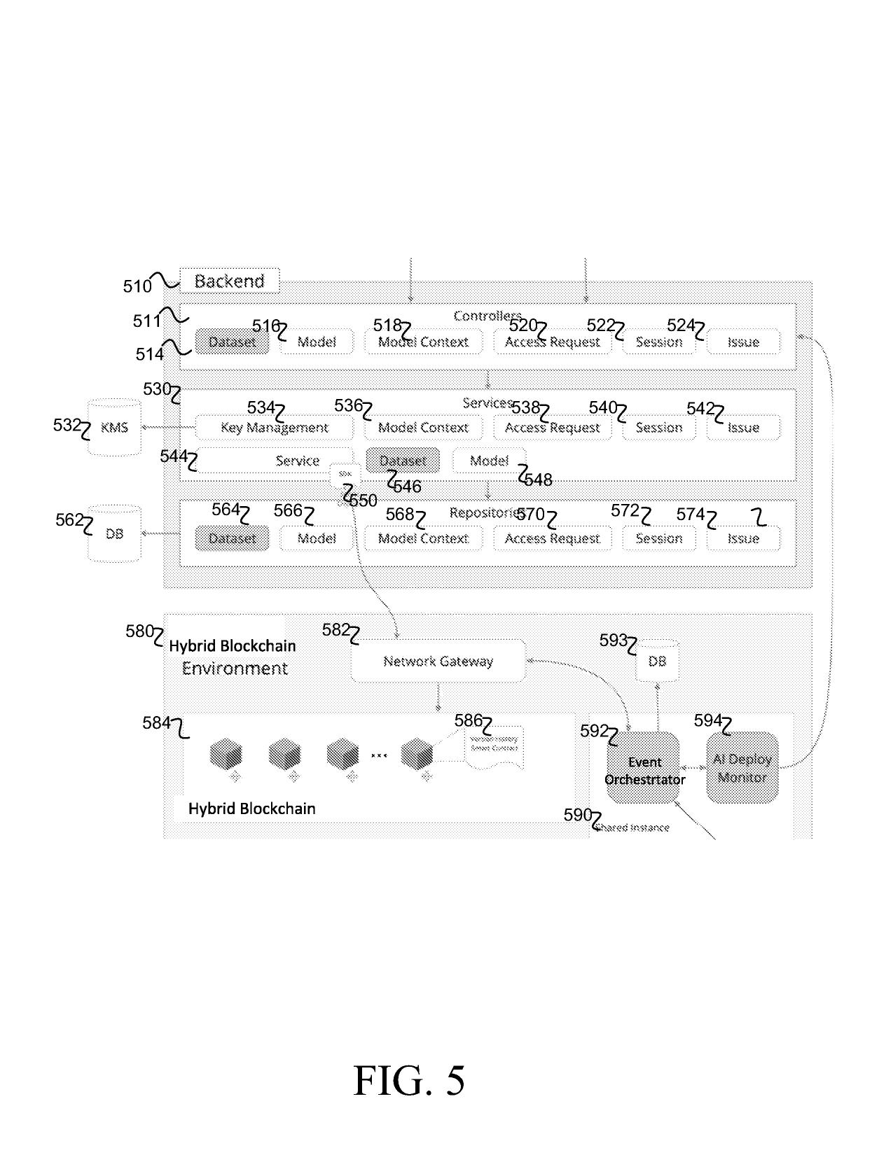

FIG. 5 shows another architecture example of a system for AI system management handled by hybrid (either private or public) blockchain deployment for a hybrid blockchain solution to manage AI model usage risk management. Using either a public or private blockchain deployment means the blockchain is organized and managed by a private entity for example a corporation or government agency for a private example and public blockchain by a public institution. The interface with the backend 510 may include through a controller module 511 such as dataset 514, model 516, model context 518, access request 520, session 522, issue 524, etc. This is for the management and governance of AI models via blockchain. The private blockchain 584 ensures security controls and data privacy controls for customers and users which is managed within their information technology (IT) system. A public blockchain 584 example would utilize a public blockchain here. The private blockchain 584 can periodically save important data to the public blockchain (not shown in FIG. 5) via a blockchain event orchestration service, just as a public blockchain 584 would if that were employed.

The hybrid (public or private) blockchain controllers 511 may interface with a services module 530. Such services module 530 may include its database storage 532 as well as any number of functions such as but not limited to private blockchain key management for cryptographic key infrastructure used to bind public keys with respective identities of organizations, users, and auditors to ensure tamper-proof accountability and audibility 534, the key management module for public or private blockchain is the controller 511 and cryptographic key custodian of different public and private keys used to the validity of AI dataset, models, and model context information via tamper-proof accountability.

AI model context 536 information is processed via microservices 538, AI dataset and model access requests are processed via microservices 540, AI session information is processed via microservices 542, blockchain management takes incoming secure data requests and manages the service to store specific mission-associated AI data, AI model, and AI model context information onto tamper-proof blockchain 544, AI model dataset information is processed via microservices 546, and AI model information is processed via microservices 548. Such services 544 blockchain management function may include a software development kit (SDK) 550 that is configured to send and deploy to a network gateway 582 as shown. This is for the secure storage of specific mission-associated AI data, AI model, and AI model context information onto a tamper-proof private blockchain or public blockchain.

The services module 530 may interface with a repositories module 560. Such a repositories module 560 may have its own database storage 562 as well as any number of functions such as but not limited to AI datasets 564, AI models 566, AI model contexts 568, access requests 570, generative AI session information 572, and issue resolutions 574. This is for the secure capture of the data repository that flows downstream from the Controller modules to the Services modules. The data is then stored within 562 databases and transmitted to a private blockchain instance via 582 network gateways, or public blockchain if so employed.

FIG. 5shows how the network gateway 582 communicates with the SDK 550 in a hybrid (public or private) blockchain environment 580. The hybrid blockchain 580 deployment could be a private blockchain or as described a public blockchain, and includes a custom smart contract 586 to support core AI systems data tracking, traceability, and audibility. In some examples, the blocks of either the private or public blockchain 584 may include blocks with version histories and smart contracts 586. The network gateway 582 may also be in communication with a shared instance 590 which may include an event orchestrator 592 and an AI deploy monitor 594. In some examples, the event orchestrator 592 includes its own database storage 593. In some examples, the AI deploy monitor may be in communication with the controller 511 as shown. This is for the monitoring of AI systems transaction results by querying the event orchestrator 592. This concludes how a hybrid blockchain is deployed within an organization's control. External modules like 592 event orchestrator can be used to interact with external public or private blockchains or turned off and all AI systems information will be stored on the hybrid blockchain.

As mentioned, in some examples, the hybrid blockchain 580 may be a private or public blockchain. In such a way, the public or private blockchain environment 580 with public or private blockchain 584 could be utilized as described, the examples are not intended to be limiting but could be either in different examples.

### AI System Dataset Examples

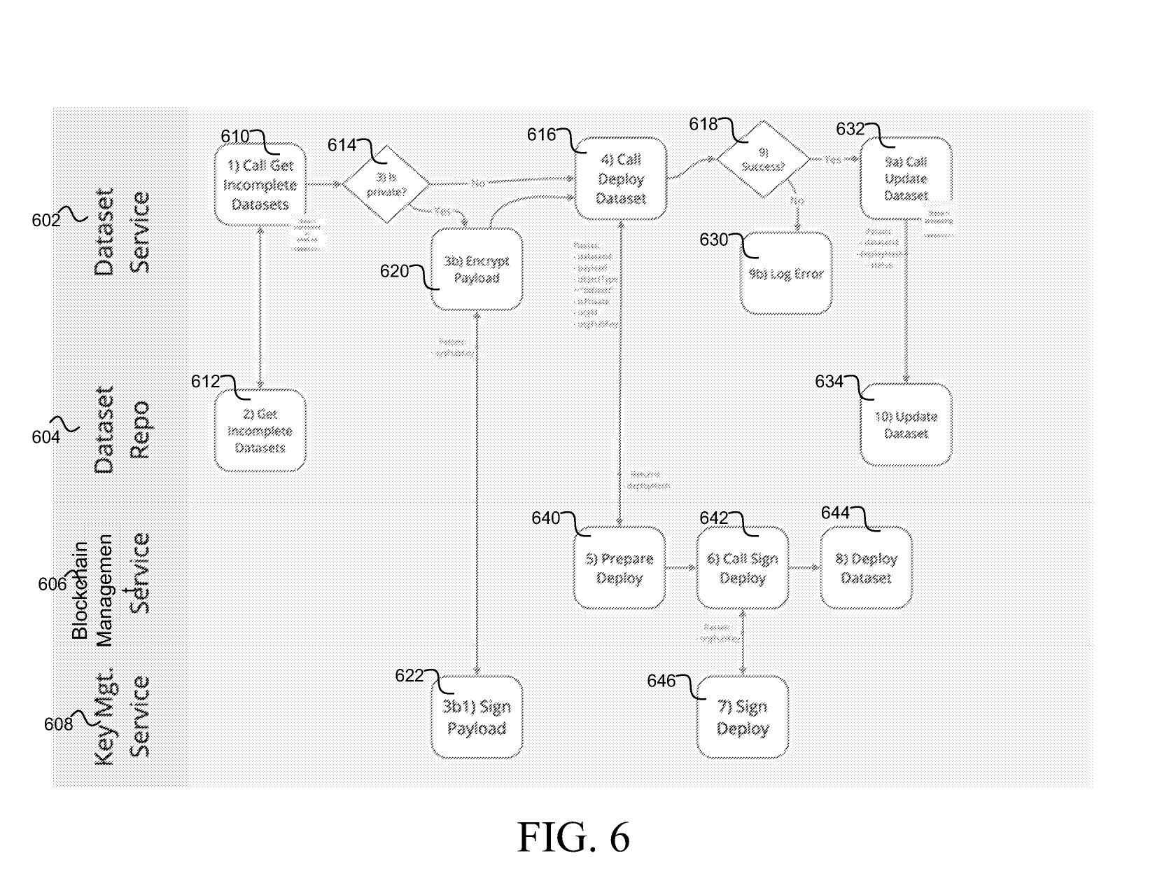

FIG. 6 is a flow chart example of how AI system datasets may flow through the AI system and when it is encrypted to be stored on a blockchain. The datasets need to verify the information is accurate and then is signed by the private key of the organization and stored on the blockchain. FIG. 6 shows the layers of dataset service 602, dataset repository 604, proprietary service 606 and key management service 608.

The flow chart of FIG. 6 begins with a call to get an incomplete dataset 610. In such examples, the AI system calls 610 a dataset repository 604 and pulls an incomplete dataset in 612. Next, a decision may be made to move to step 614 and determine if the dataset is private and mission-associated AI system information. If yes, the AI system will encrypt 620 the data by calling key management service 608 to provide the encryption keys to encrypt the data. If the information is not private 616 the AI system will call blockchain management service 606 and prepare to deploy the dataset in 640. The AI system may then call and sign the deployment information 642 and call the key management service 608 to encrypt the data and sign the deployment information. Then the AI system will officially deploy the data in 644. This information will flow back to the calls deploy dataset 616 and if is deemed to be a success 618 the dataset data elements will be communicated in 632 and dataset repository 604 registers the update in 634. If success determination is no, 618 not successful, then the AI system logs the error 630 and ends the workflow.

### Event Orchestration Examples

FIG. 7 is a flow chart showing an example how AI system dataset flows Event Orchestrator from a private blockchain to a public blockchain. Event orchestrator is shown in FIG. 1 as element 192, FIG. 5 as element 592. The Event Orchestrator may be a middleware service that is used to reliably consume, store and filter events that a public blockchain node emits on state changes. It may be used to connect to multiple nodes. The event orchestrator may be used to establish connections to the nodes on blockchain and handle the complexity of interacting with the network. In some examples, the event orchestrator is able to determine whether to store data in a non-blockchain data storage, a private blockchain, or a public blockchain. User input may help make this determination along with decision trees and programmed decision factors. In such a way, the event orchestrator can receive data, filter data and cause storge of the data in one of these three data stores: non-blockchain, public or private blockchain.

FIG. 7depicts an architectural and workflow diagram of the blockchain event orchestration service 720. The main process module of the event orchestrator 732 takes in information from three disparate nodes: blockchain Node 1, 710, blockchain Node 2, 712, and blockchain Node N,714, where N can be any number of additional nodes as configured in the config.node_connections 728. Events emitted by these nodes may be parsed by their respective blockchain event handler 1, 722, blockchain event handler 2, 724, and blockchain event handler 3, 726, before being passed on to the main event orchestration process. Optionally, these events may be sorted into the database 730 and cached in an external database (DB) 740 to maintain a historical chronology of events in the event that a monitoring client disconnects. Node connection addresses and other variables may be configured through the config.toml 742, allowing for a degree of customization.

The event orchestrator itself 720 may then stream all incoming events from multiple nodes to a single Event Stream Server 734 that can be used by the AI Management Monitor 744. Further, clients 746 may access the RESTful application programming interface (API) 736 to query specific information directly from the event orchestrator.

### Smart Contract Examples

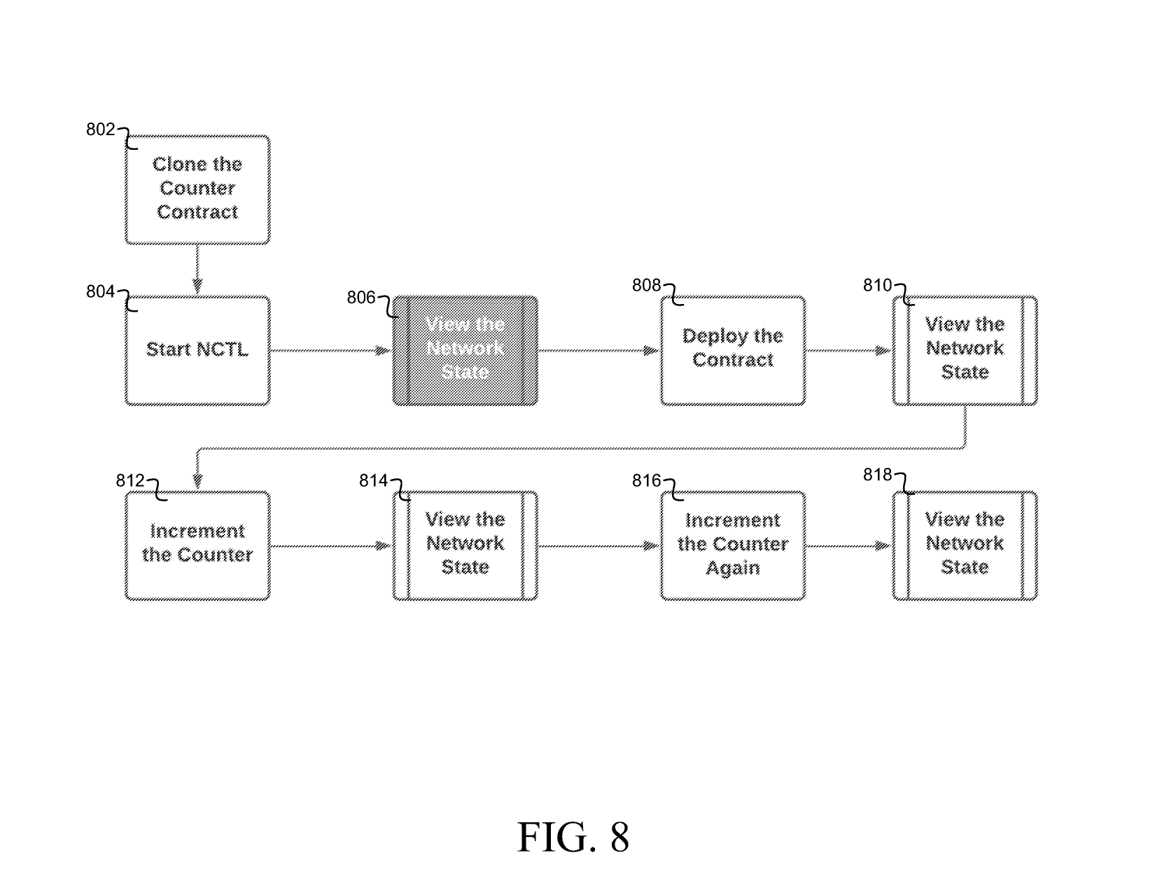

FIG. 8 depicts a workflow using a smart contract to interact with an AI system to store metadata information on a blockchain. The smart contract of FIG. 8 is also depicted in FIG. 1 as elements 186 and 187 for the private and public blockchains respectively and FIG. 5 as element 586. This process may be automated and each version of the AI data information is captured and versioned via an immutable smart contract system. A smart contract is a self-executing program that automates the actions required in a digital agreement. Once completed, the transactions are trackable and irreversible.

As shown in the example of FIG. 8, the system clones the AI system metadata smart contract from a remote repository 802 onto their terminal. They proceed to start NCTL (Network/Node Control) 804, which creates a local, small-scale testing environment that simulates the blockchain.

After verifying that it is running correctly by viewing the network state 806, they can deploy the AI system metadata smart contract 808, which installs business logic on the simulated blockchain through the associated application programming interface (API). The AI system metadata smart contract triggers a Counter program that increments a number when an entry point is called in 812. Successful execution of the deployment and installation of the smart contract can be verified by once again viewing the network state 810. After the successful installation of the contract code on a blockchain, the system uses a session code to call the entry point and increment the counter 812. This increases the number stored in the contract's named keys, which can be verified by viewing the network state 814. This process can be repeated as needed to demonstrate the functionality by incrementing the Counter again 816 and viewing the network state 818 a final time. This process may be automated and each version of the AI data information is captured and versioned via an immutable smart contract system. A smart contract is a self-executing program that automates the actions required in a digital agreement. Once completed, the transactions are trackable and irreversible.

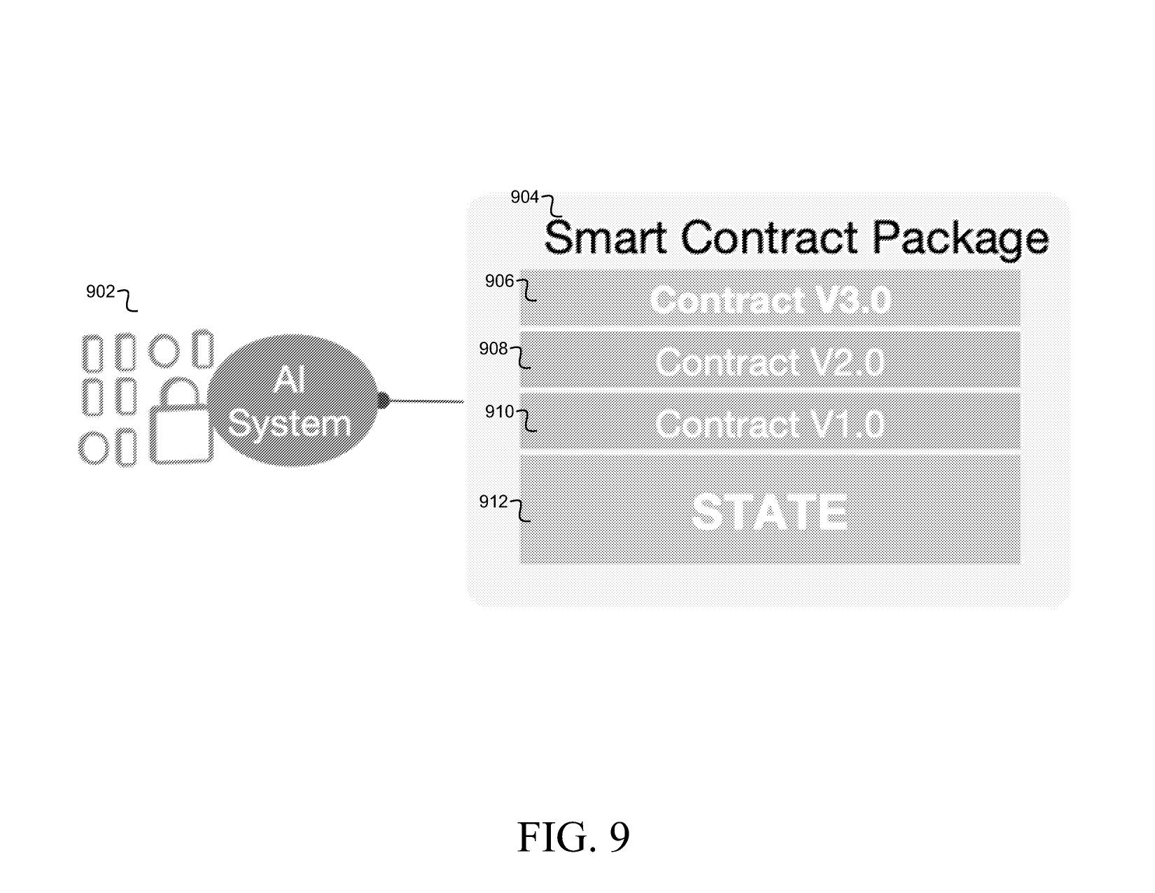

FIG. 9 is a flow chart of how the AI system metadata is captured via a smart contract and version controlled. The smart contract package contains all versions of a contract. Each version of a contract is immutable. Whenever a new version of the contract is deployed, the blockchain smart contract system increments the version of the contract according to a semantic versioning scheme.

FIG. 9 shows an example where the ability to store versions of an AI system 902 and various iterations of the AI model is in a smart contract package 904 on a blockchain. The smart contract package serves as a reference point for included contract versions, allowing them to share resources and access rights on a global state 912.

Contracts V3.0906, V2.0908, and V3.0910 are variations on the contract and include AI metadata information including dataset, AI model, model context, model versioning, model identifier, model provider, and generative AI prompt-based information. The system can call a specific contract version and the associated AI model, each of which is immutably stored in 912 as shown in a collection of all possible versioning for AI system metadata information. It is not possible to have two active versions of a single contract in a given contract package. Historical data, processed by a given version of a contract, is immutable. The data of record at a given block height will not be changed. This way all the different versions and variations of the AI systems data are properly, securely, and serially stored on the blockchain.

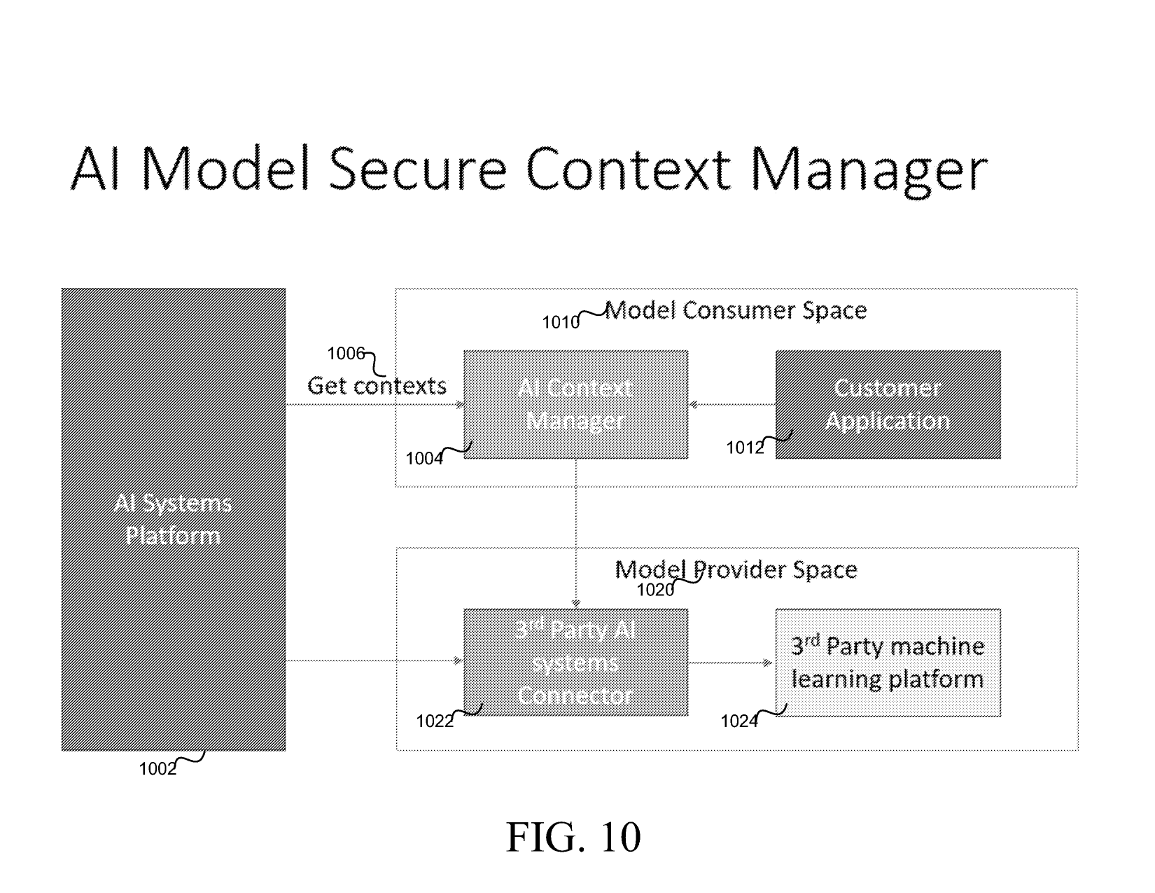

FIG. 10 is a flow chart for how to securely manage AI model context to restore previous model context and replay generative AI sessions. In FIG. 10, 1002 shows an example AI system platform that stores and processes AI model information securely by incorporating a variety of cryptographic and encryption technology to protect the AI metadata information in a tamper- proof solution. In the example, the AI System 1002 calls 1006 to get context from an AI content manager module. This is all managed within 1010 model consumer persona's information technology environment 1010. The model consumer is the downstream consumer of AI model inferencing. The model consumer end customer is expected to interact with the AI context manager module with a 1012 customer application. All this is interaction and AI metadata storage is handled by the 1004 AI context manager module. The AI context manager module calls third party AI systems connector 1022 to interact with numerous other machine learning platforms that handle machine learning training and putting models into service. This is stored and processed via 1020 the model provider space. The model provider is the organization that constructs, trains, and puts into service the original AI model. AI system platform 1002 interacts with the third-party systems connector 1022 to manage all interactions with these third-party AI systems securely to ensure all model context information can be viewed, edited, and securely stored between model consumers and model providers.

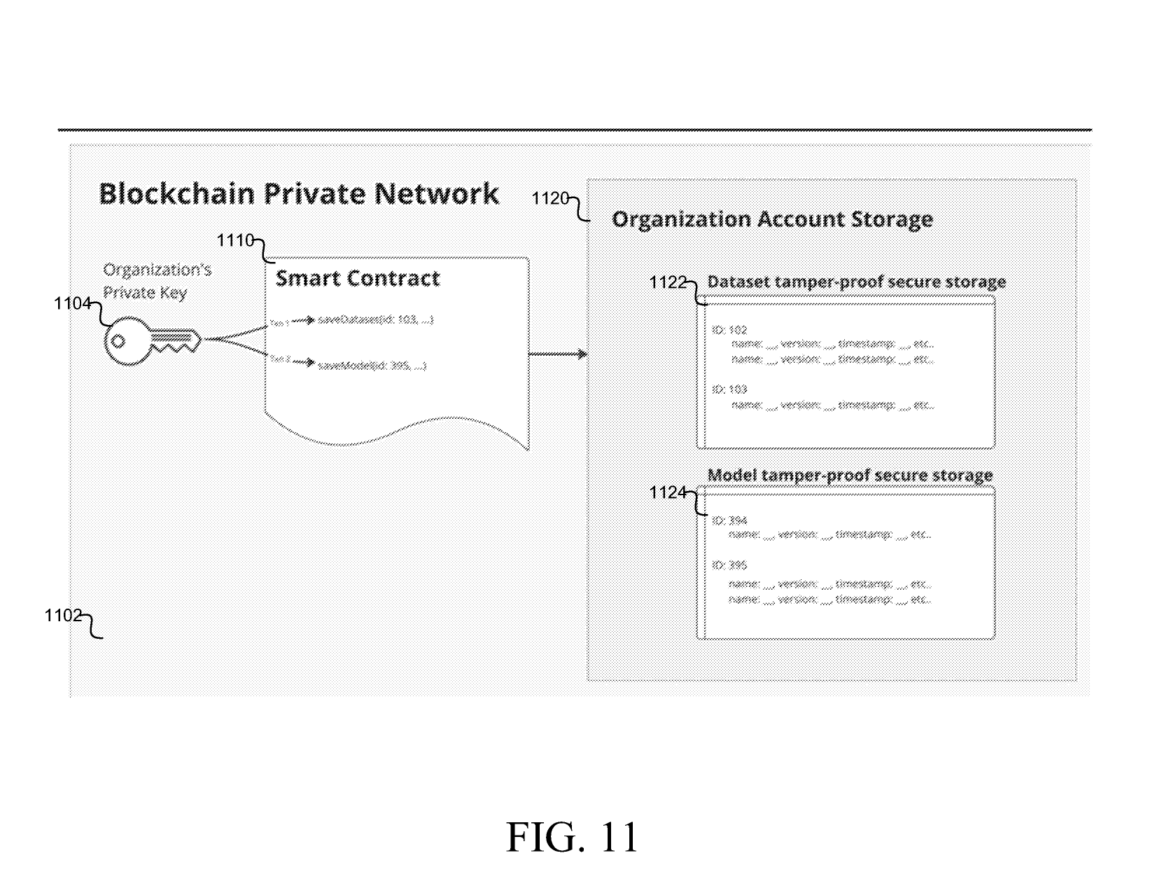

FIG. 11 depicts an example workflow which may be used to securely certify and store AI data on a private blockchain using cryptographic keys. shows a private blockchain instance 1102 referenced as element 584 in FIG. 5 and as element 184 in FIG. 1. As shown in FIG. 11, an organization's private key 1104 may be used to certify any AI data information is correct and immutable. In such examples, only the owner of the cryptographic private key 1104 may sign off and certify this information. The AI system metadata smart contract 1110 workflow may be referenced from FIG. 8. Private key 1104 signs the information and stores the AI model dataset and AI model detailed information on to the AI system metadata smart contract 1110. The organization's secure storage information 1120 is shown in FIG. 11 on the private blockchain. Storage of the AI dataset information 1122 may be in a tamper-proof format and include the dataset name, version, timestamp, dataset owner, dataset identifier, associated tags, PII, known copyright information, and if a known program has filtered out hate speech, abusive language, and profanity is contained with the datasets.

Storage of the AI model information 1124 in a tamper-proof format may include the model name, version, timestamp, model owner, model identifier, associated tags, which datasets went into constructing the model, and if the datasets contain PII, known copyright information, and if a known program has filtered out hate speech, abusive language, and profanity is contained in the datasets. This is all stored on a private blockchain 1102 that is managed by the organization to securely protect, certify, and audit their AI data information.

### Blockchain Examples

Blockchain is a distributed ledger system that maintains a continuously growing list of records, called blocks, which are linked and secured using cryptography. The basic structure of a blockchain algorithm encompasses several components that work together to ensure its functionality, security, and reliability. Together, the blockchain is able to record transaction in a distributed, and therefore difficult if not impossible to refute, change, edit, or otherwise alter an agreed upon transaction. In such a way, the blockchain provides a way to record information in a safe and secure way, which is able to be inspected and verified.

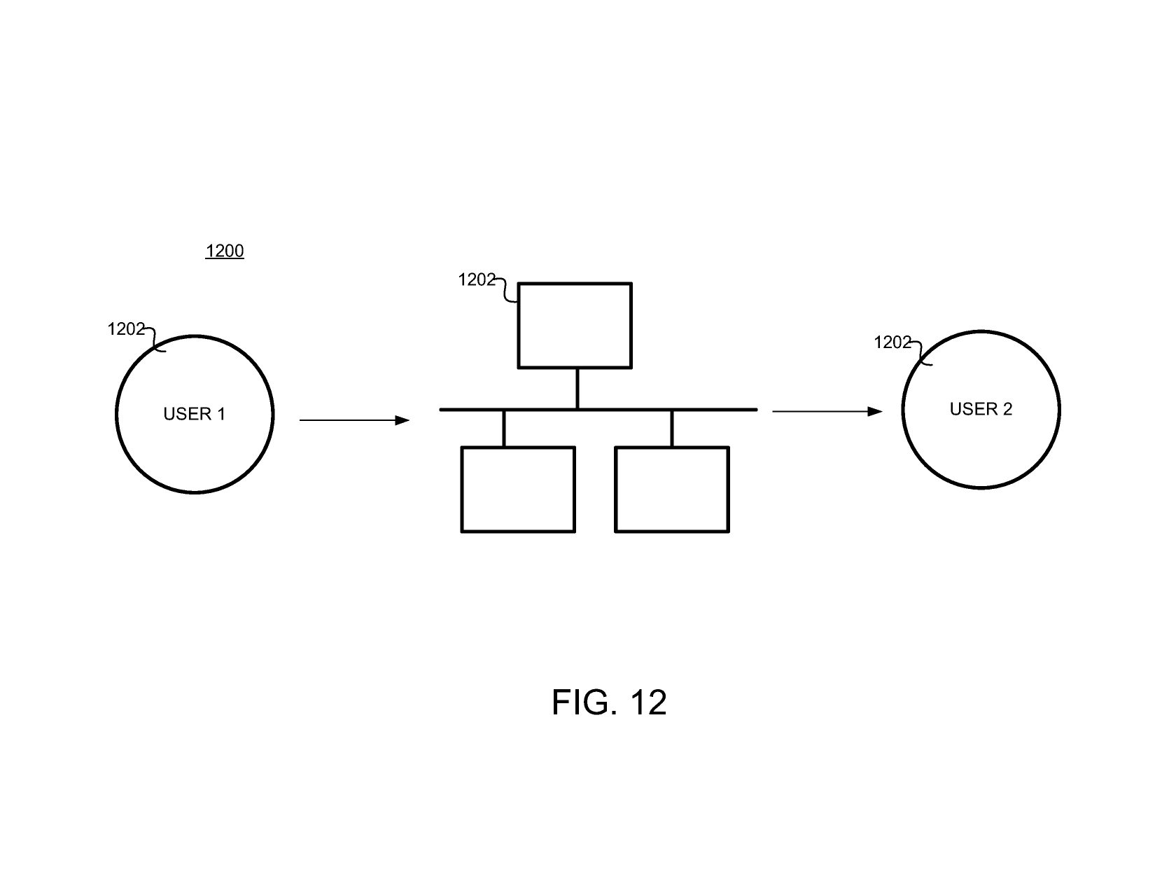

Referring to FIG. 12, an example blockchain architecture 1200 is illustrated. The blockchain architecture 1200 may comprise a blockchain computer network 1204 that facilitates transactions between users, such as User 1 1202 and User 2 1206. In the system, when User 1 1202 wants to transact with User 2 1206, the transaction is initiated and sent to the blockchain network 1204.

The blockchain network 1204 may consist of multiple nodes, or compute resources, potentially distributed across various locations. These nodes may work together to process and validate transactions through a consensus mechanism. The blockchain network can be implemented as a peer-to-peer (P2P) system, where each node in the network acts as both a client and a server. In the P2P structure, nodes can directly communicate and share data with each other without the need for a central authority, thus enhancing the network's decentralization and resilience. This architecture may allow for efficient distribution of transaction data and blocks across the network, enabling rapid propagation of information and maintaining consistency among all participants.

Blockchain networks can be categorized into three main types: public, private, and consortium (or federated) blockchains. Public blockchains are open and permissionless, allowing anyone to participate in the network, while private blockchains restrict access to a specific organization or group of participants. Consortium blockchains, a hybrid between public and private, are operated by a group of organizations that collectively maintain the network, offering a balance between transparency and control.

Referring back to the example of FIG. 12, the new recorded block, or information regarding a transaction, may then be shared among the nodes in the blockchain network 1204. The nodes then validate the transaction based on predetermined rules and protocols.

Each transaction may include a timestamp, transaction data, a cryptographic hash of the previous block (i.e., to create a chain), and a nonce (i.e., a random number used in the consensus mechanism). To validate a new transaction and achieve agreement among network participants, blockchain systems employ various consensus mechanisms, such as Proof of Work (PoW), Proof of Stake (PoS), Delegated Proof of Stake (DPoS), or Practical Byzantine Fault Tolerance (PBFT).

PoW achieves consensus by requiring network participants (e.g., miners) to solve complex mathematical puzzles, with the first to solve the puzzle earning the right to add the next block to the blockchain. The process ensures agreement on the state of the ledger by making it computationally expensive and time-consuming to alter the blockchain, as an attacker would need to redo the work for all subsequent blocks to modify a single block.

PoS achieves consensus by selecting validators to create new blocks based on the amount of cryptocurrency they hold and are willing to "stake" as collateral. This mechanism incentivizes participants to act honestly, as they risk losing their stake if they validate fraudulent transactions, while also reducing energy consumption compared to PoW systems.

DPoS achieves consensus by allowing token holders to vote for a limited number of delegates, who are then responsible for validating transactions and creating new blocks. This system combines elements of democracy with efficient block production, potentially offering faster transaction times and lower energy consumption compared to other consensus mechanisms.

PBFT achieves consensus through a voting process among a set of pre-selected nodes, requiring a supermajority agreement to validate transactions and add new blocks. This mechanism allows the network to reach consensus even if some nodes are faulty or malicious, providing both safety and liveness in partially synchronous systems.

Cryptographic hashing plays a role in blockchain technology. The hash (e.g., SHA-256) is based on the block's contents and the hash of the previous block, ensuring the integrity and immutability of the chain. In some embodiments, the hash in a Merkle root hash. The Merkle root is a single hash that represents all the transactions in a block, created by recursively hashing pairs of transactions until a single hash remains. This structure, known as a Merkle tree, allows for efficient and secure verification of the block's transactions.

After consensus is reached, the new block is added to the existing blockchain. The addition creates a new link in the chain, with the new block containing a reference (i.e., a hash) to the previous block, thereby maintaining the integrity and chronological order of the blockchain. In cases of conflicting chains, or forks, nodes typically follow the longest valid chain, which is considered the authoritative version of the blockchain.

Once the transaction is confirmed and added to the blockchain, it becomes part of the immutable ledger. At this point, the transaction between User 11202 and User 21206 is considered complete and can be verified by any participant in the network.

While blockchain technology is often associated with cryptocurrencies, its potential applications extend far beyond financial transactions. In various industries, blockchain may be utilized for supply chain management, enabling transparent tracking of goods from production to delivery. Healthcare sectors may implement blockchain for secure storage and sharing of patient records, ensuring data integrity and privacy. In the realm of digital identity, blockchain could provide individuals with greater control over their personal information. Voting systems may leverage blockchain to enhance security and transparency in elections. The technology may also be applied in intellectual property management, creating immutable records of ownership and licensing. Additionally, blockchain can enhance the Internet of Things (IoT) by facilitating secure, decentralized communication between devices. These diverse applications demonstrate the versatility and transformative potential of blockchain technology across multiple sectors.

### Computing System Examples

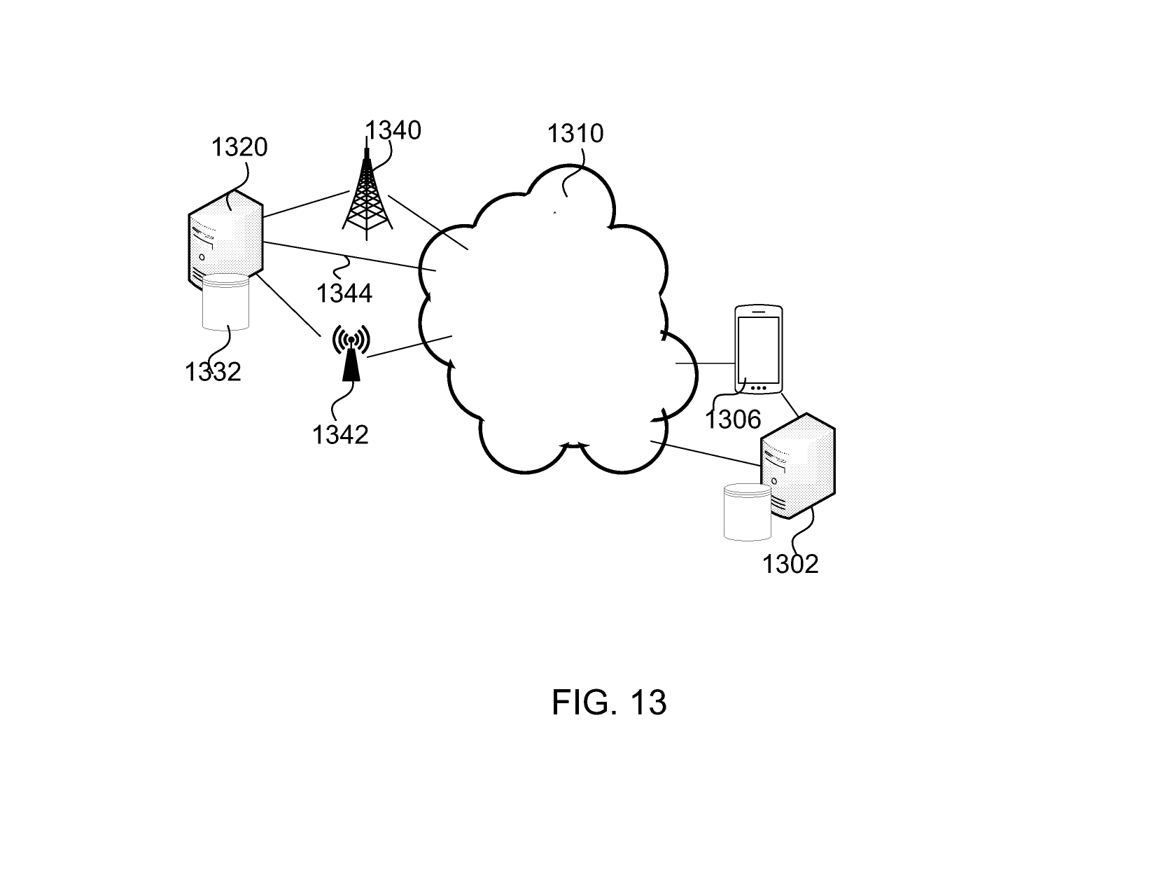

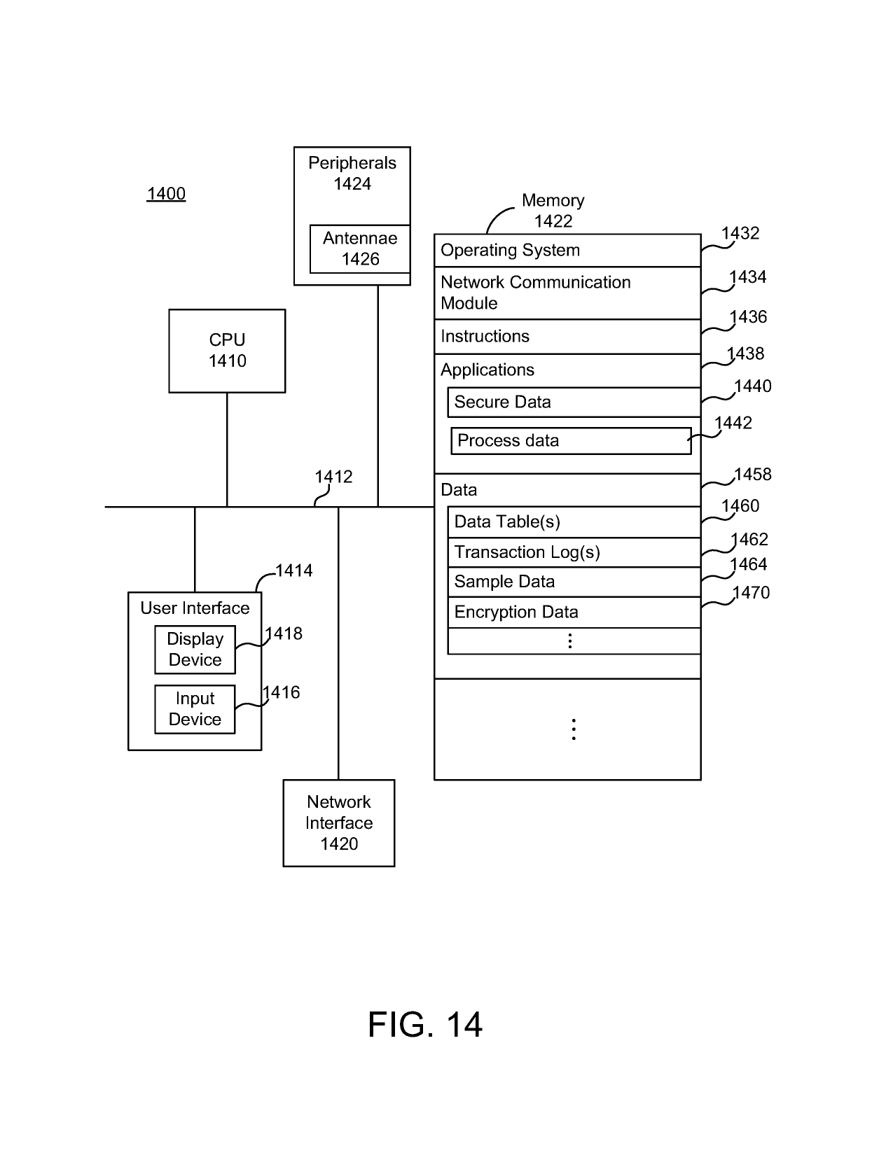

FIG. 13 shows an example networked system which could be used in the systems and methods here. In FIG. 13, the computer system 1302 described herein, including executing any examples described. The computer 1302 could be any number of kinds of computers such as those included in the administration, running, executing, or coordinating the executed tasks described herein, and/or any other another computer arrangement including those examples are described in FIG. 14.

As shown in FIG. 13, the various computing systems 1302, 1306 may be in communication with a back-end computing system 1320 and/or data storage 1332 to send and receive data regarding the operations of the harvesting systems described herein. For example, as shown in FIG. 13, data from a front end 1302, 1306, may be sent to a back-end computer system 1320 and associated data storage 1332 for storage and/or analysis. In some examples, this may include sending and receiving over a network 1310. In some examples, remote operators may interface with the systems by remote or mobile computing systems 1306. In some examples, the communication from either the front end or back end (although only back end shown in FIG. 13) may be a wireless transmission 1342 by a radio, cellular 1340 or WiFi transmission 1342 with associated routers and hubs. In some examples, the transmission may be through a wired connection 1344. In some examples, a combination of wireless and wired transmissions may be used to stream data between the back end 1320 and the system, etc.

In some examples, the transmission of data may include transmission through a network such as the internet 1310 to remote operators, back-end server computers 1320, and associated data storage 1332. Once at the back-end server computer servers 1320 and associated data storage 1332, the data may be acted upon by the remote operators. In some examples, the data may be useful to train the neural network, and/or artificial intelligence models. In such examples, the data may be stored, analyzed, used to train models, or any other kind of data analysis. In some examples, the storing, analyzing, and/or processing of data may be accomplished at the computer 1302 which is involved in the original data. In some examples, the local computer 1302 and a back-end computing system 1320 may split or share the data storing, modeling, analyzing, and/or processing. Back-end computer resources 1320 may be more powerful, faster, or be able to handle more data than may be otherwise available at the local computers 1302 on the systems. In some examples, the networked computer resources 1320 may be spread across many multiple computer resources by a cloud infrastructure. In some examples, the networked computer resources 1320 may be virtual machines in a cloud infrastructure.

FIG. 14shows an example computing device 1400 that may be used in practicing example embodiments described herein. FIG. 14 could describe computers such as 1302, 1320 or other systems as described in FIG. 13. Such computing device 1400 may be the front end and/or back-end server systems use to interface with the network, receive and analyzed data, as well as generate remote operator GUIs, additionally or alternatively, it could be a computing system as described, to gather analyze, transmit and receive data, etc. Such computer 1400 may be a device used to create and send data, as well as receive and cause display of GUIs representing data such as back-end interfaces for remote operators, etc. In FIG. 14, the computing device could be a smartphone, a laptop, tablet computer, server computer, or any other kind of computing device. The example shows a processor CPU 1410 which could be any number of processors in communication via a bus 1412 or other communication with a user interface 1414. The user interface 1414 could include any number of display devices 1418 such as a screen. The user interface also includes an input such as a touchscreen, keyboard, mouse, pointer, buttons, joystick or other input devices. Also included is a network interface 1420 which may be used to interface with any wireless or wired network in order to transmit and receive data. Such an interface may allow for a smartphone, for example, to interface a cellular network and/or WiFi network and thereby the Internet. The example computing device 1400 also shows peripherals 1424 which could include any number of antennae 1426 for communicating wirelessly such as over cellular, WiFi, NFC, Bluetooth, infrared, or any combination of these or other wireless communications. The computing device 1400 also includes a memory 1422 which includes any number of operations executables by the processor 1410. The memory in shows an operating system 1432, network communication module 1434, instructions for other tasks 1438 and applications 1438 such as secure data 1440 and/or process data 1442. Also included in the example is for data storage 1458. Such data storage may include data tables 1460, transaction logs 1462, user data 1464 and/or encryption data 1470. The computing device 1400 also include one or more graphical processing units (GPUs) for the purposes of accelerating in hardware computationally intensive tasks such as execution and or evaluation of the neural network engine and enhanced image exploitation algorithms operating on the multi-modal imagery collected. The computing device 1400 may also include one or more reconfigurable hardware elements such as a field programmable gate array (FPGA) for the purposes of hardware acceleration of computationally intensive tasks.

### Conclusion

As disclosed herein, features consistent with the present inventions may be implemented by computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various machines may be used with programs written in accordance with teachings of the invention, or it may be more convenient to construct a specialized apparatus or system to perform the required methods and techniques.

Aspects of the method and system described herein, such as the logic, may be implemented as functionality programmed into any of a variety of circuitry, including programmable logic devices ("PLDs"), such as field programmable gate arrays ("FPGAs"), programmable array logic ("PAL") devices, electrically programmable logic and memory devices and standard cell-based devices, as well as application specific integrated circuits. Some other possibilities for implementing aspects include: memory devices, microcontrollers with memory (such as 1PROM), embedded microprocessors, Graphics Processing Units (GPUs), firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal- oxide semiconductor field-effect transistor ("MOSFET") technologies like complementary metal-oxide semiconductor ("CMOS"), bipolar technologies like emitter-coupled logic ("ECL"), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks by one or more data transfer protocols (e.g., HTTP, FTP, SMTP, and so on).

Unless the context clearly requires otherwise, throughout the description and the claims, the words "comprise," "comprising," and the like are to be construed in an inclusive sense as opposed to an exclusive or exhaustive sense; that is to say, in a sense of "including, but not limited to." Words using the singular or plural number also include the plural or singular number respectively. Additionally, the words "herein," "hereunder," "above," "below," and words of similar import refer to this application as a whole and not to any particular portions of this application. When the word "or" is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. Etc.

What is claimed is:

1. A method to secure data for use in Al systems training datasets, the method comprising:
receiving new data from a data source;
filtering, by an orchestration event manager, the received new data to determine whether the new data is descriptive or mission specific;
causing storage, by the orchestration event manager, of a first subset of the new data, determined to be descriptive, on a non-blockchain database;
causing storage, by the orchestration event manager, of a second subset of the new data, determined to be mission specific, on a private blockchain;
causing storage, by the orchestration event manager, of secure computer security hash information from the private blockchain storage, to a public blockchain.

2. The method of claim 1, the second subset of the new data is stored on the private blockchain by smart contract.

3. The method of claim 2, wherein the smart contract includes Al metadata information including dataset, Al model, model context, model versioning, model identifier, model provider, and generative Al prompt-based information.

4. The method of claim 3, further comprising, calling a specific contract version and an associated Al model, each stored on the private blockchain in a collection of all possible versioning for Al system metadata information.

5. The method of claim 4, further comprising, linking the descriptive information stored on the non-blockchain databases with mission specific data stored on the private blockchain.

6. The method of claim 2, wherein the second subset of data includes at least one of, Al training dataset information like dataset type, short description, associated tags, personally identifiable information (PII), known copyright information.

7. The method of claim 1, wherein the orchestration event manager receives, stores and filters events from a public blockchain node regarding state changes.

8. The method of claim 7, wherein the events from the public blockchain node are parsed by a blockchain event handler before being passed on to the orchestration event manager.

9. The method of claim 8, wherein the events from the public blockchain node are cached in an external database to maintain a historical chronology of events in the event that a monitoring client disconnects.

10. The method of claim 8, wherein the blockchain event handler periodically checkpoints a capability to post a state root hash of the private blockchain to the public blockchain.

11. The method of claim 2, wherein the private blockchain includes blocks with version histories and smart contracts and the public blockchain includes blocks with proprietary trust and smart contracts.

12. The method of claim 11, wherein the smart contracts are configured to track history of Al dataset parameters, Al model parameters, Al model context parameters, and session information for cryptographic storage of Al data information until a public blockchain that is accessible via a decentralized ledger format is available.

13. The method of claim 1, further comprising, causing storage, by the orchestration event manager, of additional data to the public blockchain, after receiving instruction from a user.

14. A method of securing data, comprising:storing and retrieving data, by an event orchestrator push model, from a circular buffer filtering data for storing in a public blockchain via a private blockchain instance.

15. The method of claim 14, wherein the circular buffer includes a forced serialization of asynchronous events.

16. The method of claim 14, further comprising, by an Al system, storing descriptive information on non-blockchain databases; linking the descriptive information stored on the non-blockchain databases with mission associated and secured information stored on the private blockchain.
